(19) United States
(12) Patent Application Publication
(10) Pub. No.: US 2008/0075988 A1
(43) Pub. Date: Mar. 27, 2008

(54) FUEL CELL SYSTEM AND METHOD OF CONTROLLING A FUEL CELL SYSTEM

(75) Inventors: Takahiro SUZUKI, Tokyo (JP); Masato Akita, Yokohama-shi (JP); Kei Matsuoka, Kawasaki-shi (JP); Ryosuke Yagi, Kawasaki-shi (JP); Akihiro Ozeki, Chiryu-shi (JP); Yuusuke Sato, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/857,214

(22) Filed: Sep. 18, 2007

(30) Foreign Application Priority Data
Sep. 27, 2006 (JP) 2006-262985

(51) Int. Cl. H01M 8/06

(52) U.S. Cl. 429/19; 429/24

(57) ABSTRACT

A fuel cell system includes a plurality of fuel cell stacks; a mixing tank in which a liquid fuel mixture is stored; a plurality of liquid feed pumps configured to feed the liquid fuel mixture to the fuel cell stacks; a switch unit configured to switch on and off of a load connected with the fuel cell stacks: and a controller configured to control a feed of the fuel mixture to the fuel cell stacks, according to an ambient temperature of the fuel cell stacks.

### CROSS REFERENCE TO RELATED APPLICATIONS AND INCORPORATION BY REFERENCE

This application is based upon and claims the benefit of priority from the prior Japanese Patent Application No. P2006-262985, filed on Sep. 27, 2006; the entire contents of which are incorporated herein by reference.

### BACKGROUND OF THE INVENTION

1. Field of the Invention

The present invention relates to a fuel cell system suitable for a direct fuel cell that generates electric power by directly supplying liquid fuel, such as alcohol, to a fuel cell stack and a method of controlling the fuel cell system.

2. Description of the Related Art

A direct fuel cell that directly supplies liquid fuel, such as alcohol, to a fuel cell stack does not require an auxiliary machine such as a vaporizer, a reformer, and the like. Therefore, miniaturized batteries used for portable electronic equipment has been expected. In such a known direct fuel cell, such as a circulation-type fuel cell system, an alcohol solution is directly supplied to the fuel cell stack. In operation, protons are extracted, exhaust materials, such as water exhausted from the fuel cell stack, are circulated to a mixing tank which is provided on an upstream side of the fuel cell stack.

In such a circulation-type fuel cell system, power generation efficiencies and loads are adjusted within an optimum range by controlling alcohol solution concentrations, temperatures, and the like. However, the control method is not sufficient because the power generation efficiencies and the loads are adjusted only in a comparatively narrow range.

A fuel cell system in which a plurality of fuel cell blocks are arranged in series or parallel has been proposed (For instance, refer to JP-A (KOKAI) No. 2004-79537). In the fuel cell system, a wide load range change can be realized by selecting one or more fuel cell blocks as needed.

However, in the fuel cell system disclosed in JP-A (KOKAI) No. 2004-79537, since auxiliary machines for feeding fuels or collecting exhaust materials, and the like, are required for each fuel cell stacks, it is difficult to minimize the entire size of the fuel cell system. Conversely, if the auxiliary machines are omitted in the fuel cell system disclosed in JP-A (KOKAI) No. 2004-79537, it will be difficult to collect materials discharged from the fuel cell blocks effectively, and the power generation efficiencies cannot be controlled sufficiently within an optimum range.

### SUMMARY OF THE INVENTION

An aspect of the present invention inheres in a fuel cell system encompassing a plurality of fuel cell stacks; a mixing tank in which a liquid fuel mixture is stored, the liquid fuel mixture containing mixing a fuel and an exhaust fluid from the fuel cell stacks; a liquid feed pump configured to feed the liquid fuel mixture to the fuel cell stacks; a switch unit configured to switch on and off a load connected with the fuel cell stacks: an ambient thermometer provided adjacent to the fuel cell stacks, measuring an ambient temperature of the fuel cell stacks: and a controller configured to control the feed of the fuel mixture to the fuel cell stacks, according to the ambient temperature.

Another aspect of the present invention inheres in a fuel cell system encompassing a plurality of fuel cell stacks; a mixing tank in which a liquid fuel mixture is stored, the liquid fuel mixture containing a fuel and an exhaust fluid from the fuel cell stacks; a plurality of liquid feed pumps configured to feed the liquid fuel mixture to the fuel cell stacks, respectively; a switch unit configured to switch on and off a load connected with the fuel cell stacks: an ambient thermometer provided adjacent to the fuel cell stacks, measuring an ambient temperature of the fuel cell stacks: and a controller configured to control the feed of the fuel mixture to the fuel cell stacks by controlling the liquid feed pumps, according to the ambient temperature.

Still another aspect of the present invention inheres in a method of controlling a fuel cell system, encompassing connecting an arbitrary fuel cell stack with a load, the arbitrary fuel cell selected from a plurality of fuel cell stacks electrically connected in series; generating electricity by feeding a liquid fuel mixture to the arbitrary fuel cell, the liquid fuel mixture containing a fuel and an exhaust fluid from the fuel cell stacks; measuring an ambient temperature of the arbitrary fuel cell stack; controlling a cooler provided adjacent to the arbitrary fuel cell stack and an amount of the liquid fuel mixture fed to the fuel cell stacks, according to a measurement result of the ambient temperature.

### BRIEF DESCRIPTION OF DRAWINGS

FIG. 1 is a block diagram illustrating an example of a fuel cell system according to the present embodiment;

FIG. 2 is schematic diagram illustrating a single fuel cell according to the embodiment;

FIG. 3 is a block diagram illustrating a first example of a switch unit according to the embodiment;

FIG. 4 is a block diagram illustrating an example of a change of the switch unit of FIG. 3;

FIG. 5 is a block diagram illustrating an example of a change of the switch unit of FIG. 3;

FIG. 6 is a block diagram illustrating an example of a change of the switch unit of FIG. 3;

FIG. 7 is a block diagram illustrating a second example of the switch unit according to the embodiment;

FIG. 8 is a block diagram illustrating an example of a change of the switch unit of FIG. 7;

FIG. 9 is a block diagram illustrating an example of a change of the switch unit of FIG. 7;

FIG. 10 is a block diagram illustrating an example of a change of the switch unit of FIG. 7;

FIG. 11 is a block diagram illustrating an example of a feeding mechanism according to the embodiment;

FIG. 12 is a block diagram illustrating an example of a feeding mechanism according to the embodiment;

FIG. 13 is a block diagram illustrating an example of a feeding mechanism according to the embodiment; and

FIG. 14 is a block diagram illustrating an example of a feeding mechanism according to the embodiment;

FIG. 15 is a block diagram illustrating an example of a feeding mechanism including a three ways valve according to the embodiment;

FIG. 16 is a block diagram illustrating an example of a feeding mechanism to a first fuel cell stack using the three ways valve according to the embodiment;

FIG. 17 is a block diagram illustrating an example of a feeding mechanism to a second fuel cell stack using the three ways valve according to the embodiment;

FIG. 18 is a block diagram illustrating an example of a feeding mechanism including first and second valves according to the embodiment;

FIG. 19 is a block diagram illustrating an example of a feeding mechanism to the second fuel cell stack using the second valve according to the embodiment; and

FIG. 20 is a block diagram illustrating an example of a feeding mechanism to the first fuel cell stack using the first valve according to the embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified. In the following descriptions, numerous details are set forth such as specific signal values, etc. to provide a thorough understanding of the present invention. However, it will be obvious to those skilled in the art that the present invention may be practiced without such specific details.

### —Fuel Cell System—

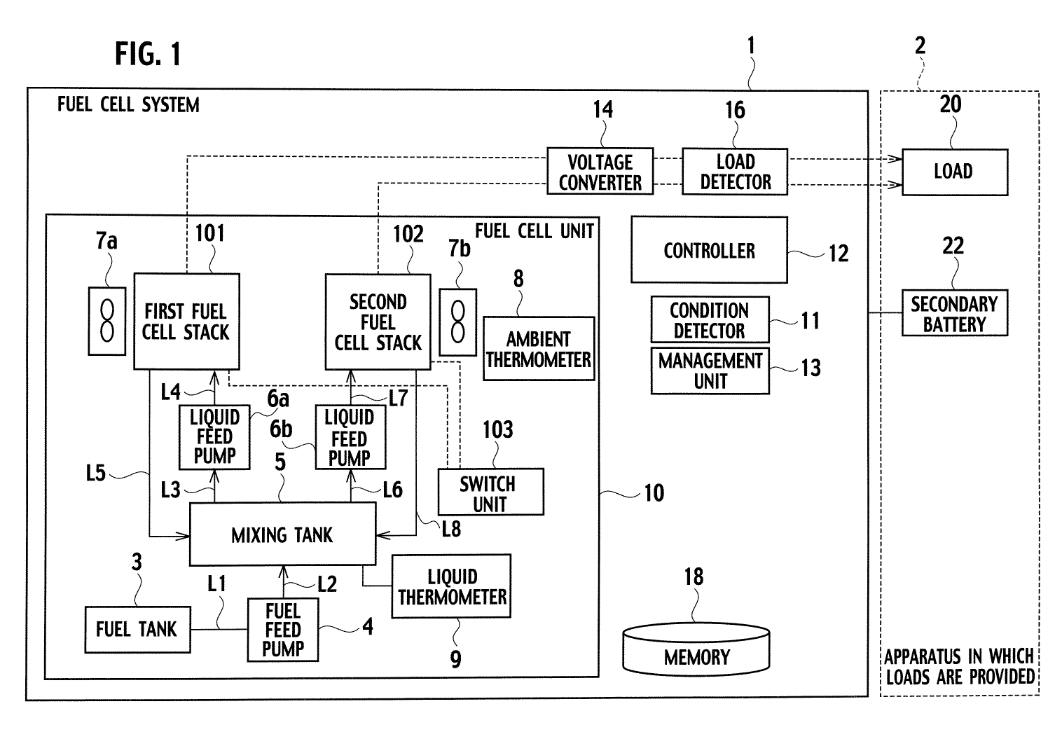

As shown in FIG. 1, a fuel cell system 1 according to an embodiment of the present invention includes a plurality of fuel cell stacks (for example, a first fuel cell stack 101 and a second fuel cell stack 102), a mixing tank 5 in which a liquid fuel mixture is stored, a plurality of liquid feed pumps 6a and 6b configured to feed the liquid fuel mixture to the fuel cell stacks, a switch unit 103 configured to switch on and off a load 20 connected with the fuel cell stacks 101 and 102, and a controller 12 configured to control feed of the liquid fuel mixture according to an ambient temperature of the fuel cell stacks 101 and 102.

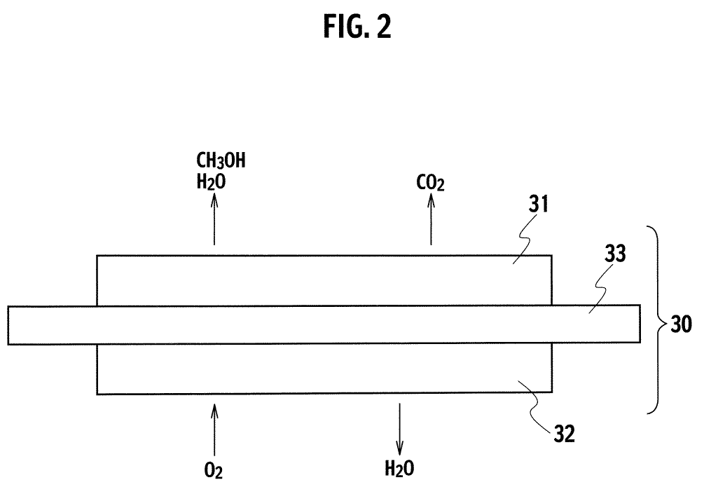

As shown in FIG. 2, the first fuel cell stack 101 and the second fuel cell stack 102 include a single fuel cell 30. The single fuel cell 30 includes an anode electrode 31, a cathode electrode 32, and an electrolyte membrane 33 provided between the anode electrode 31 and the cathode electrode 32. Detailed configurations of the single fuel cell 30 are not limited. The anode electrode 31 may include passages (not shown) for fuel flow. The cathode electrode 32 may include a passage (not shown) for flow of air or oxidizing agent including oxygen. As for the electrolyte membrane 33, a proton-conductive solid polymer electrolyte membrane may be used.

The number of single fuel cells 30 is not limited to one. Practically, a plurality of single fuel cells 30 may be stacked with each other to provide predetermined voltage outputs and current outputs. In general, a stacked assembly, which is composed of a plurality of single fuel cells 30, is referred to as a “stack”. The number of single fuel cells 30 can be arbitrarily changed.

The first fuel cell stack 101 and the second fuel cell stack 102 of FIG. 1 are electrically connected in series to the load 30. The switch unit 103 switches the load 30 on and off. An “apparatus 2 in which loads are provided” represents a wide variety of electric devices in which loads are provided through the fuel cell system 1. For example, a personal computer (PC), a personal digital assistant (PDA), a digital camera, a mobile phone, and the like may be used for the apparatus 2 in which loads are provided.

A load detector 16 detects load values of the load 20. The load detector 16 is connected between the first and second fuel cell stacks 101 and 102 and the load 20. The controller 12 controls the on and off states of the switch unit 103 according to the load values detected by the load detector 16 and determines whether to generate electric power by either or both of the first fuel cell stack 101 and the second fuel cell stack 102. A voltage converter 14 is electrically connected in series between the load detector 16 and the first and second fuel cell stacks 101 and 102.

FIG. 1 shows an example of the fuel cell system 1 including two fuel cell stacks of the first fuel cell stack 101 and the second fuel cell stack 102, however, the number of fuel cell stacks is not particularly limited. The more fuel cell stacks are installed, the more auxiliary machines may be required, thus, it makes it difficult to miniaturize the entire size of the fuel cell system 1.

When a balance of the necessary number of fuel cell stacks and the size of the system are considered in a case where the fuel cell system 1 as shown in FIG. 1 is used as a portable battery which outputs electric power of about 30 W, it is preferable to arrange two stacks of the first fuel cell stack 101 and the second fuel cell stack 102 in one fuel cell system 1. The fuel cell system 1 having two stacks of the first fuel cell stack 101 and the second fuel cell stack 102 can double the load value and also realizes miniaturization of the system compared to a case where one stack is arranged in the fuel cell system 1.

FIG. 1 shows an example in which the first fuel cell stack 101 and the second fuel cell stack 102 are dispersed from one another. However, the first fuel cell stack 101 and the second fuel cell stack 102 can be physically stacked with each other.

Coolers 7a and 7b are arranged in an area adjacent to the first fuel cell stack 101 and the second fuel cell stack 102. The coolers 7a and 7b cool the first fuel cell stack 101 and the second fuel cell stack 102. As for the coolers 7a and 7b, cooling fans, water-cooling jackets, and the like may be used. The controller 12 controls cooling capacities of the coolers 7a and 7b. For example, in a case in which cooling fans are used as the coolers 7a and 7b, the controller 12 controls the cooling capacities by changing rotation speeds of the cooling fans 7a and 7b.

A thermometer (ambient thermometer) 8 is provided in an ambient area surrounding the first fuel cell stack 101 and the second fuel cell stack 102. The thermometer 8 measures ambient temperature of the ambient area. Measured temperatures (ambient temperatures) are output to the controller 12. For example, if the ambient temperature is higher than a set temperature, the controller 12 controls cooling capacities of the coolers 7a and 7b to cool down the first fuel cell stack 101 and the second fuel cell stack 102 so that power generation can be performed at an optimum temperature.

The fuel tank 3 stores liquid fuel including alcohol such as methanol, ethanol, and the like. As for the liquid fuel, methanol of 99% purity, or a water-methanol mixture with a concentration of 10 mol/L or more may be suitable. The fuel tank 3 is connected to the fuel feed pump 4 through a line L1.

The fuel feed pump 4 is connected to the mixing tank 5 through a line L2. The operations of the fuel feed pump 4 are controlled by the controller 12. For example, when the controller 12 controls the fuel feed pump 4, the liquid fuel stored in the fuel tank 3 is fed to the mixing tank 5 through the lines L1 and L2.

As for the liquid fuel mixture in the mixing tank 5, a diluted methanol solution with an initial concentration of from about 1.5M to about 2.5M may be suitable. In the mixing tank 5, a thermometer (liquid thermometer) 9 is provided to measure temperatures of the liquid fuel mixture. The controller 12 detects temperatures measured by the thermometer 9 and compares a temperature difference between the temperature measured by the thermometer 9 and the ambient temperature measured by the ambient thermometer 8. When the temperature difference is equal to or less than a set value, it indicates that the cooling capacity of the coolers 7a and 7b is insufficient. In such a case, the controller 12 changes the cooling capacity of the coolers 7a and 7b so that the liquid fuel mixture has an optimum temperature for power generation. The thermometer 9 may be provided with a line L3 or a line L5, which feed the liquid fuel mixture to the first fuel cell stack 101 and the second fuel cell stack 102.

The mixing tank 5 is connected to a line L5, which is connected to an outlet side of the first fuel cell stack 101. The mixing tank 5 is also connected to a line L8, which is connected to an outlet side of the second fuel cell stack 102. The line L5 is a passage that collects exhaust fluids exhausted from the first fuel cell stack 101. The line L8 is a passage that collects exhaust fluids exhausted from the second fuel cell stack 102. Exhaust fluids collected from the lines L5 and L8 include methanol fuel, which is not utilized in the fuel cell stacks 101 and 102, and reaction products such as water, carbon dioxide, and the like.

In the fuel cell system 1 as shown in FIG. 1, it may be preferable that the line L5 and line L8 are connected to the outlets of the anode electrode side of the first fuel cell stack 101 and the second fuel cell stack 102. Since the line L5 and the line L8 are connected to anode electrode sides of the first fuel cell stack 101 and the second fuel cell stack 102, exhaust fluids generated in the anode electrode can be collected efficiently. Thus, even if the load value of the first fuel cell stack 101 and the second fuel cell stack 102 is greatly changed by switching the switch unit 103, the generated exhaust fluids can be collected efficiently in the mixing tank 5. Although, it is not shown in FIG. 1, exhaust fluids generated in the cathode electrodes are exhausted by pumps and the like.

The liquid feed pump 6a is connected to the mixing tank 5 through a line L3. The liquid feed pump 6a is connected to the first cell stack 101 through a line L4. The liquid feed pump 6b is connected to the mixing tank 5 through a line L6. The liquid feed pump 6b is connected to the first cell stack 101 through a line L7. The controller 12 controls operations of the liquid fuel pumps 6a and 6b.

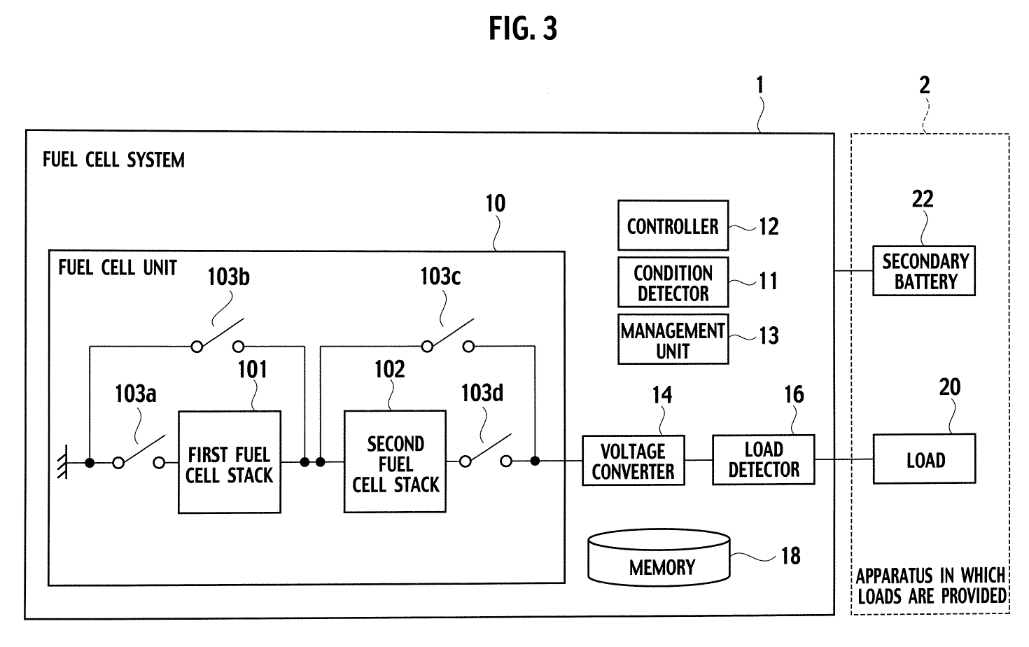

The switch unit 103 includes a plurality of switches (referred to as FIG. 3 through FIG. 10). The switch unit 103 switches the load 20 on and off, the load 20 being electrically connected in series with the first fuel cell stack 101 and the second fuel cell stack 102. Examples of switching method are described later by using FIG. 3 through FIG. 10.

The controller 12 controls operations of the fuel feed pump 4, the liquid feed pumps 6a and 6b, the coolers 7a and 7b, and the switch unit 103 of the fuel cell system 1. The controller 12 also controls concentrations, and the like of the liquid fuel mixture in the mixing tank 5.

The fuel cell system 1 in FIG. 1 further includes a condition detector 11, a management unit 13, and a memory 18. The condition detector 11 detects a condition of the apparatus in which loads 2 are provided. The condition detector 11 outputs a condition detection result to the controller 12. The controller 12 controls a power generation output according to the condition detection result. Here, “a condition of the apparatus 2 in which loads are provided” referred to as operating conditions, remaining battery levels, and the like of the apparatus 2 in which loads are provided.

For example, the condition detector 11 detects conditions of the apparatus in which loads are provided, such as a rest state, a standby state, and the like. The condition detector 11 also detects the output of the load value when the apparatus in which loads are provided is in the operating state. Then, the controller 12 controls the switching unit 103 and determines whether to generate electric power by using either or both of the first fuel cell stack 101 and the second fuel cell stack 102, according to the state detected by the condition detector 11.

The controller 12 can also switch the secondary battery 22 on and off, the secondary battery 22, which is charged and discharged repeatedly, according to an amount of charge in the secondary battery 22. For example, in a case in which the secondary battery 22 is sufficiently charged and the power generation by the fuel cell system 1 is not required, the controller 12 controls disconnects the load 20 from the first fuel cell stack 101 and the second fuel cell stack 102. In a case in which the secondary battery 22 has a charge equal to or less than a predetermined charge, the controller 12 operates both of the first fuel cell stack 101 and the second fuel cell stack 102 so that the maximum electric power output is output to the apparatus in which loads 2 are provided. Here, the condition detector 11 can be disposed in the apparatus in which loads are provided.

The management unit 13 manages total power generation times of each of the first fuel cell stack 101 and the second fuel cell stack 102, by counting connection times of the load 20 connected to the first fuel cell stack 101 and the second fuel cell stack 102, and outputs management information to the controller 12. The controller 12 switches on and off the load of the first fuel cell stack 101 and the second fuel cell stack 102 according to the management information output from the management unit 13.

Since the controller 12 switches the load 20 on and off according to the total power generation times of each of the first fuel cell stack 101 and the second fuel cell stack 102, an operation in which only one of the first fuel cell stack 101 and the second fuel cell stack 102 being run for a long time can be avoided. And, the life time of the first fuel cell stack 101 and the second fuel cell stack 102 can be adjusted by a user. The life time of one stack can be extended longer than the life time of other stack and performance deterioration will be slower than other stacks by running only one of the first fuel cell stack 101 and the second fuel cell stack 102 for a long time.

The memory 18 stores necessary information and setting conditions for the controller 12, detection results detected by the ambient thermometer 8 and the liquid thermometer 9, setting values of optimum temperatures and concentrations of the liquid fuel mixture for power generation.

### —FIRST EXAMPLE OF THE SWITCH UNIT 103Example of the Switch Unit 103—

FIG. 3 shows a first example of the switch unit 103 of FIG. 1. The fuel tank 3, the fuel feed pump 4, the mixing tank 5, the liquid feed pumps 6a and 6b, the coolers 7a and 7b, the ambient thermometer 8, and the liquid thermometer 9 are not shown in FIG. 3.

As shown in FIG. 1, the switch unit 103 includes switches 103a, 103b, 103c, and 103d. The switch 103a is connected in series with the fuel cell stack 101. The switch 103b is connected in parallel with the fuel cell stack 101 and the switch 103a. The switch 103d is connected in series with the fuel cell stack 102 and the voltage converter 14. The switch 103 is connected in parallel with the switch 103d and the second fuel cell stack 102.

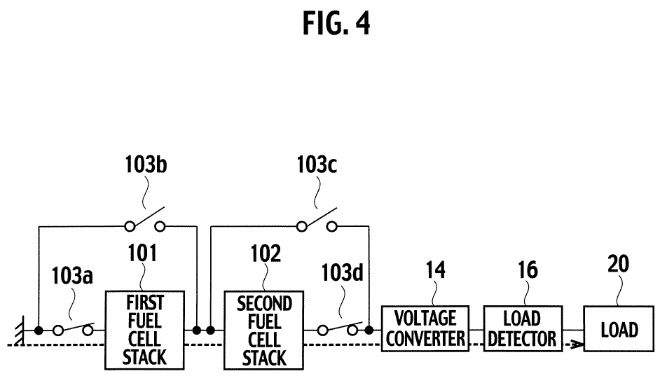

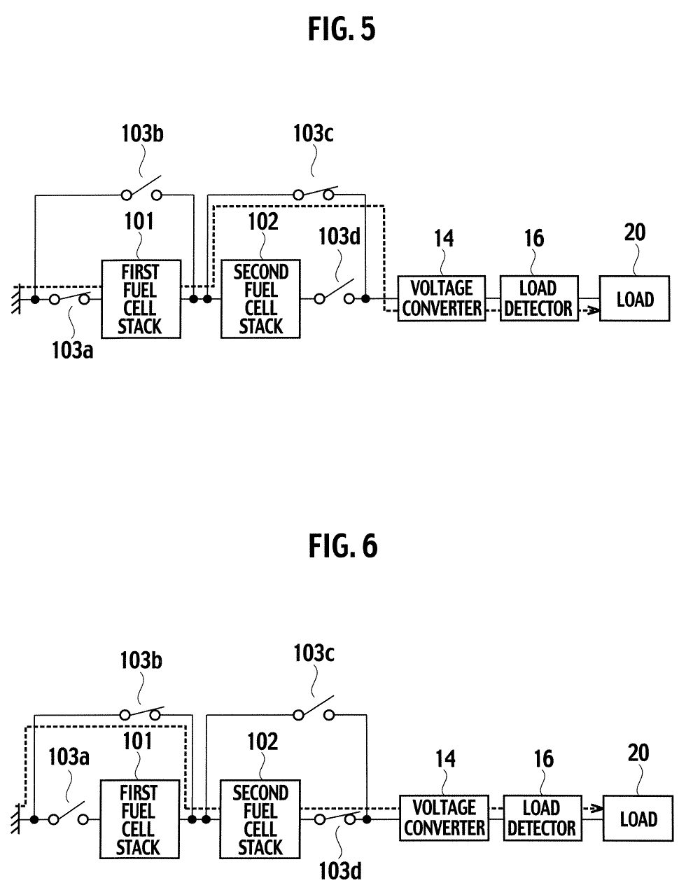

When the controller 12 in FIG. 3 switches on the switches 103a and 103d, as shown in FIG. 4, the first fuel cell stack 101 and the second fuel cell stack 102 are serially connected to the load 20. As a result, the maximum electric power output of the fuel cell system 1 can be obtained. When the controller 12 in FIG. 3 switches on the switches 103a and 103c, as shown in FIG. 5, only the first fuel cell stack 101 is connected to the load 20 through the voltage converter 14 and the load detector 16. As a result, half of the electric power output of the power output shown in FIG. 4 can be obtained.

When the controller 12 in FIG. 3 switches on the switches 103b and 103d, only the second fuel cell stack 102 is connected to the load 20 through the voltage converter 14 and the load detector 16. As a result, half of the electric power output of the power output shown in FIG. 4 can be obtained.

According to the fuel cell system as shown in FIG. 1, the load values of the load 20 can be decreased by half or be doubled by switching the switches 103a through 103d, without operating other parameters related to the power generation or changing operation conditions of the first fuel cell stack 101 and the second fuel cell stack 102.

### —SECOND EXAMPLE OF THE SWITCH UNIT 103—

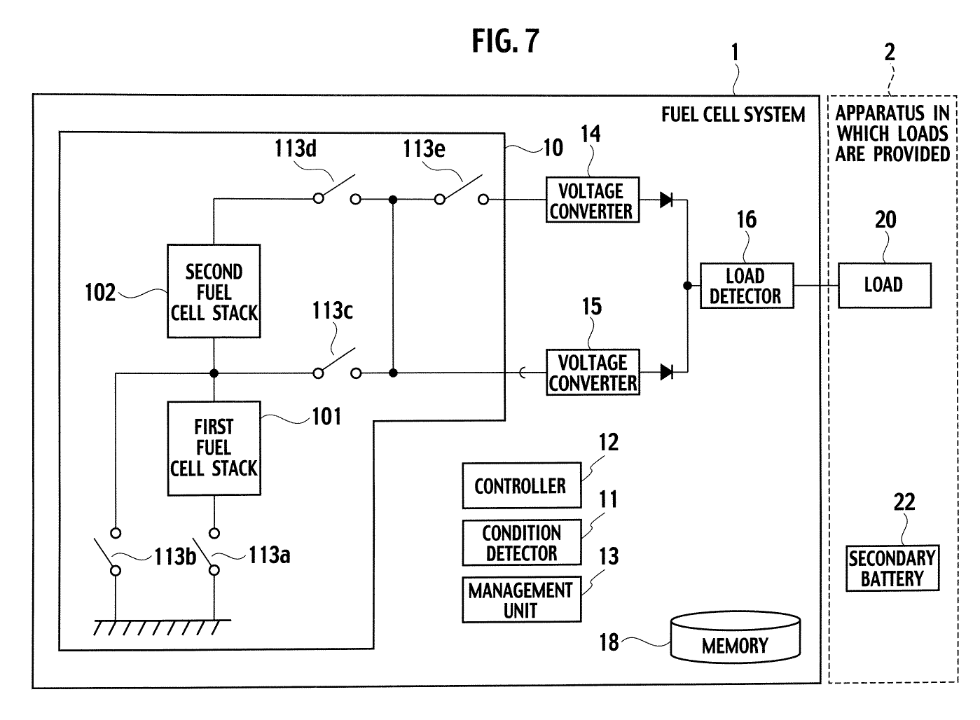

FIG. 7 shows a second example of the switch unit 103 shown in FIG. 1. The fuel tank 3, the fuel feed pump 4, the mixing tank 5, the liquid feed pumps 6a and 6b, the coolers 7a and 7b, the ambient temperature thermometer 8, and the liquid temperature thermometer 9 shown in FIG. 1 are not shown in FIG. 7.

As shown in FIG. 7, the fuel cell system 1 includes voltage converters 14 and 15. Diodes are disposed between the voltage converters 14 and 15 and the load detector 16. As shown in FIG. 7, the switch unit 103 includes a plurality of switches 113a, 113b, 113c, 113e and 114e. The switch 113a is connected in series with the fuel cell stack 101. The switch 113b is connected in parallel with the fuel cell stack 101. The switch 113c is connected in series with the switch 113b and the voltage converter 15.

The switch 113d is connected in series with the fuel cell stack 102 and the voltage converter 14. The switch 113c is connected in parallel with the switch 103d and the second fuel cell stack 102. The switch 113d is connected in series with the second fuel cell stack 102. The switch 113e is connected in series with the switch 113d and voltage converter 14.

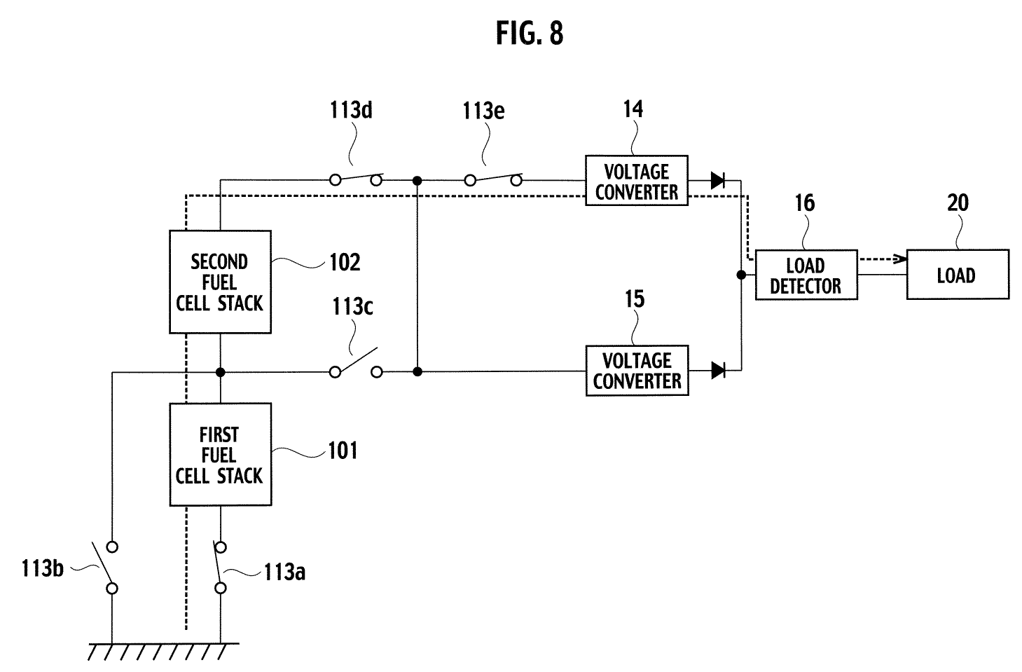

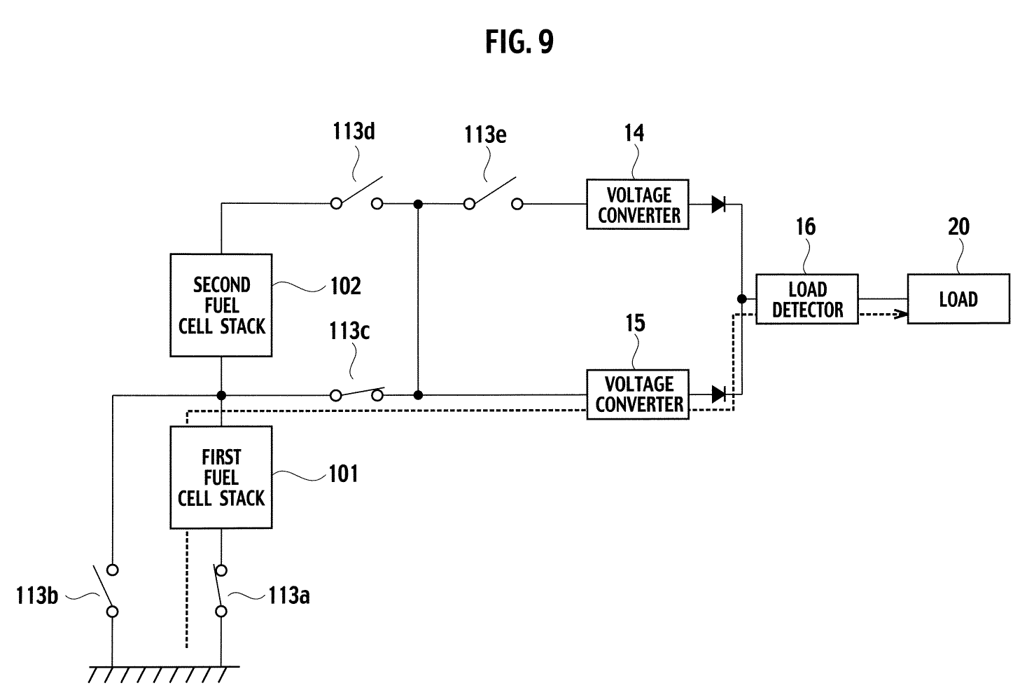

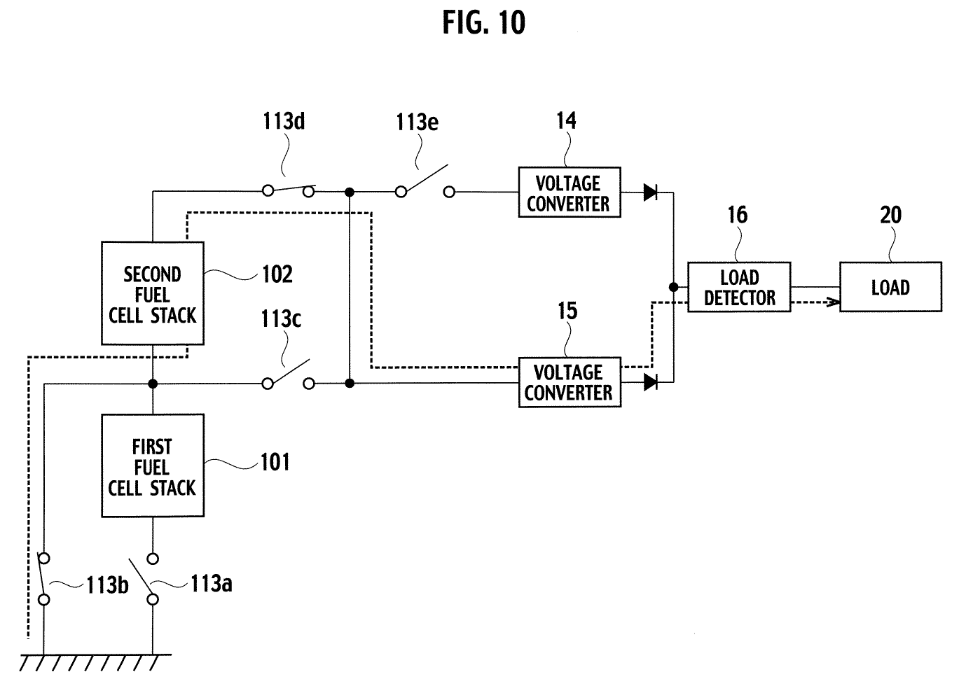

When the controller 12 in FIG. 7 switches on the switches 113a, 113d and 113e, as shown in FIG. 8, the first fuel cell stack 101 and the second fuel cell stack 102 are serially connected to the load 20 via the voltage converter 14 and the load detector 61. When the controller 12 switches on the switches 113a and 113c, as shown in FIG. 9, only the first fuel cell stack 101 is connected to the load 20 via the voltage converter 14 and the load detector 16. When the controller 12 switches on the switches 113b and 113d, as shown in FIG. 10, only the second fuel cell stack 102 is connected to the load 20 via the voltage converter 14 and the load detector 16.

In the fuel cell system as shown in FIG. 7, the load values of the load 20 can be also decreased by half or double by switching the switches 113a-113e, without operating other parameters related to power generation or changing operation conditions of the first fuel cell stack 101 and the second fuel cell stack 102.

### —Feed Control of the Liquid Fuel Mixture—

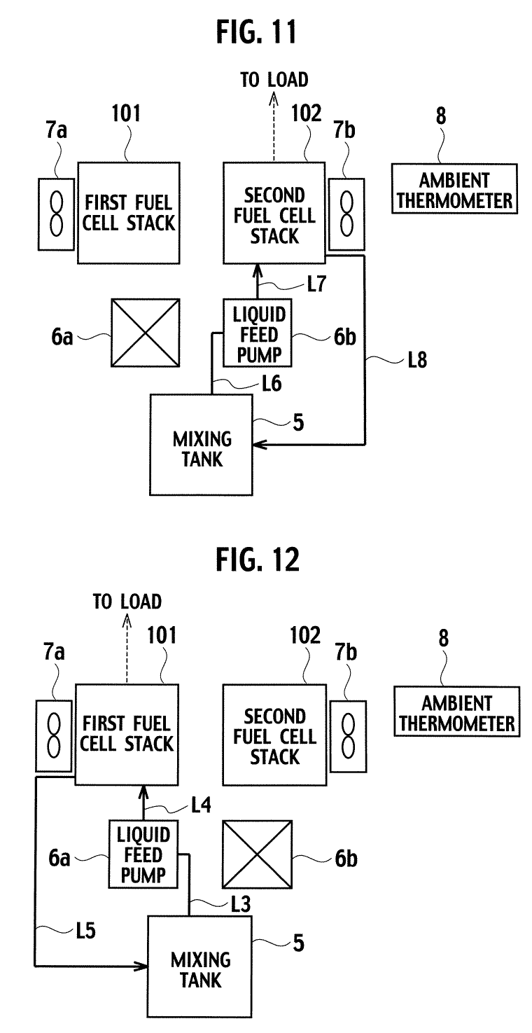

FIG. 11 shows an example of a feed control of the liquid fuel mixture when only the second fuel cell stack 102 is connected to the load 20 as shown in FIG. 6 and FIG. 10. In FIG. 11, only the liquid feed pump 6b is working. The liquid feed pump 6b feeds the liquid fuel mixture in the mixing tank 5 to the anode electrode of the second fuel stack 102 through lines L6 and L7, air is introduced to the cathode electrode, and electric power is generated.

A part of the exhaust fluids generated in the anode electrode and apart of the liquid fuel mixture, which was not reacted in the anode electrode, are discharged to the mixing tank 5 through the line L8. At this time, the ambient temperature thermometer 8 measures the ambient temperature of the second fuel cell stack 102 and outputs the measured ambient temperature to the controller 12. The controller 12 controls the temperatures of the second fuel cell stack 102 to maintain an optimum temperature for power generation by changing the cooling capacity of the cooler 7b.

As shown in FIG. 5 and FIG. 9, in a case in which only the first fuel cell stack 101 is connected to the load 20, as shown in FIG. 12, the liquid feed pump 6a feeds the liquid fuel mixture in the mixing tank 5 to the anode electrode of the first fuel cell stack 101 through the lines L3 and L4, air is introduced to the cathode electrode, and electric power is generated.

A part of the exhaust fluids generated in the anode electrode and a part of the liquid fuel mixture, which was not reacted in the anode electrode, are discharged to the mixing tank 5 through the line L5. The ambient temperature thermometer 8 measures the ambient temperature surrounding the first fuel cell stack 101 and outputs the measured ambient temperature to the controller 12. The controller 12 controls temperatures of the first fuel cell stack 102 to maintain an optimum temperature for power generation by changing the cooling capacity of the cooler 7a.

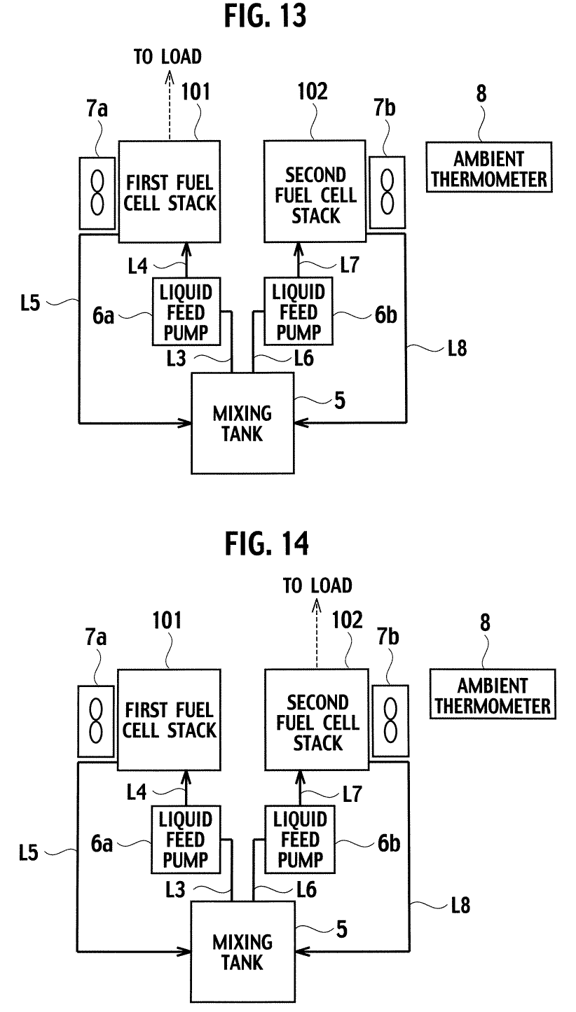

As shown in FIG. 13 and FIG. 14, in a case in which only one of the first fuel cell stack 101 and the second fuel cell stack 102 is connected to the load 20, the liquid fuel mixture can be fed to both of the first fuel cell stack 101 and the second fuel cell stack 102 by using the liquid feed pumps 6a and 6b.

In examples shown in FIG. 11 and FIG. 12, when the ambient temperature is equal to or less than the set value, temperatures of the first fuel cell stack 101 and the second fuel cell stack 102 can be controlled to maintain the optimum temperature by controlling the cooling capacities of the coolers 7a and 7b. However, when the ambient temperature is higher than the set value, it is difficult to ensure proper airflow for cooling the stack with a small fan and the like. Therefore, the size the coolers 7a and 7b should be increased.

When the ambient temperature is higher than the set value, as shown in FIG. 13 and FIG. 14, the controller 12 feeds the liquid fuel mixture to the fuel cell stack, which is not connected to the load 20. Since the liquid fuel mixture is circulated in the fuel cell system 1, the temperature of the liquid fuel mixture is decreased, thus making it possible to maintain the temperature of the first fuel cell stack 101 and the second fuel cell stack 102 at the optimum level for power generation and miniaturize the entire size of the fuel cell system 1. Therefore, a fuel cell system in which the power generation efficiencies are optimized is provided, a load can be changed within a wide range, and miniaturization can be achieved.

As shown in FIG. 13 and FIG. 14, the liquid feed pumps 6a and 6b are utilized to control the amount of liquid fuel mixture fed to the fuel cell stacks. The feed amount of one of the liquid feed pumps 6a and 6b, which is not connected to the load 20, can be changed according to the ambient temperature so that the first and second fuel cell stacks 101 and 102 have the optimum temperature for power generation.

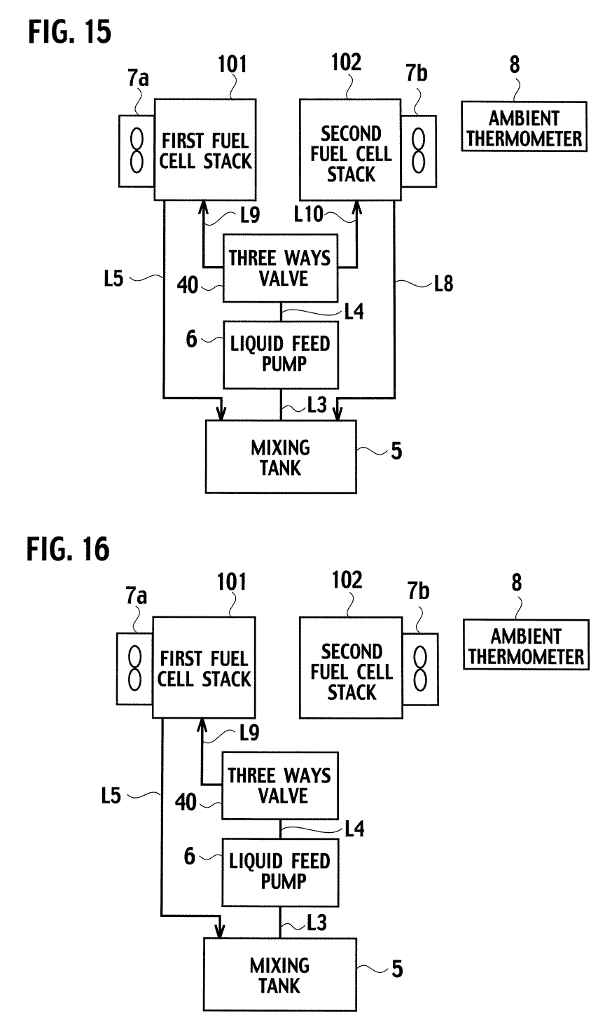

In the present embodiment, a plurality of liquid feed pumps 6a and 6b are used. As shown in FIG. 15, for example, a three ways valve 40, which controls the feed of the liquid fuel mixture in the mixing tank 5 to the first and second fuel cell stacks 101 and 102, can be provided in place of the liquid feed pumps 6a and 6b to miniaturize the fuel cell system. The operation of the three ways valve 40 is controlled by the controller (not shown).

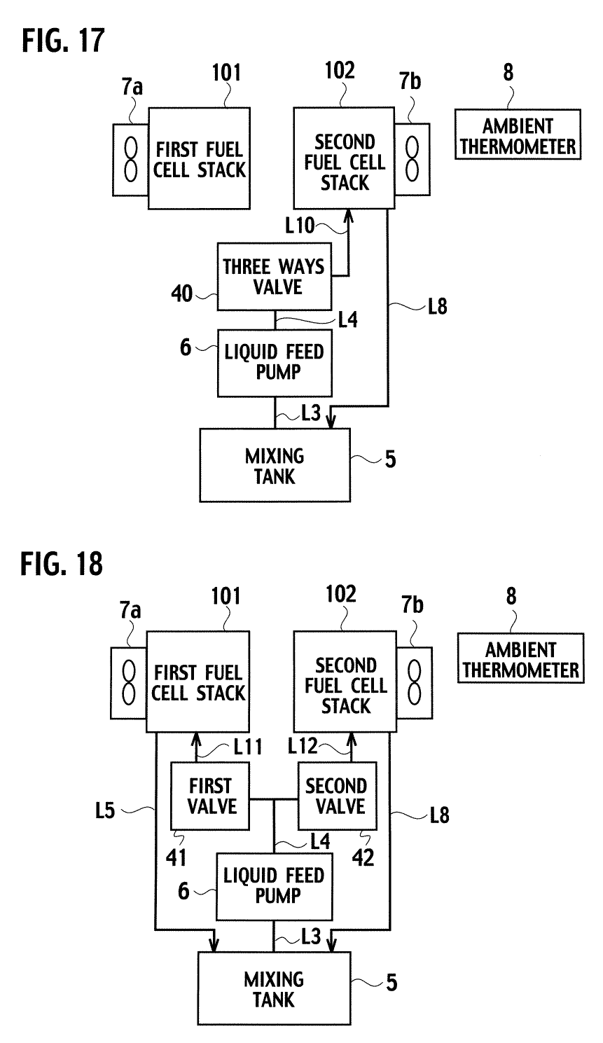

In FIG. 15, one liquid feed pump 6 is connected to the mixing tank 5 through the line L4. The three ways valve 40 is connected to the first fuel cell stack 101 through a line L9. The three ways valve is connected to the second fuel cell stack 102 through a line L10. As shown in FIG. 16, the three ways valve 40 flows the liquid fuel mixture in the line L4 to the first fuel cell stack 101 through the line L9. As shown in FIG. 17, the three ways valve 40 flows the liquid fuel mixture in line L4 to the second fuel cell stack 102 through the line L10.

As shown in FIG. 18, a plurality of valves can also be connected between the liquid pump 6 and the first and second fuel cell stacks 102 in place of the three ways valve 40. A first valve 41 and a second valve 42 are connected to a downstream side of the line L4, respectively. The first valve 41 is connected to the first fuel cell stack 101 through a line L11. The second valve 42 is connected to the second fuel cell stack 102 through a line L12.

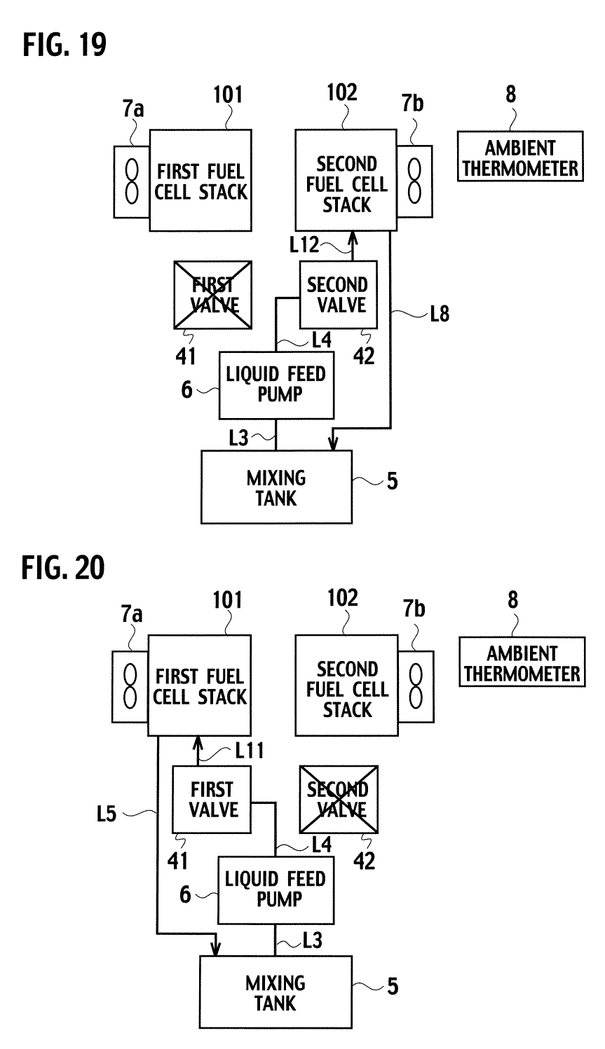

As shown in FIG. 19, the second valve 42 flows the liquid fuel mixture in the line L4 to the second fuel cell stack 102 through the line L12. As shown in FIG. 20, the first valve 41 flows the liquid fuel mixture in line L4 to the first fuel cell stack 101 through the line L11.

### —Method for Controlling the Fuel Cell System—

A method for controlling the fuel cell system is described. For example, the fuel cell system 1 as shown in FIG. 1 is electrically connected to the load 20 in the apparatus in which loads are provided. Then, the controller 12 obtains various information from the apparatus in which loads are provided. For example, the condition detector 11 detects a condition of the apparatus in which loads are provided and outputs a condition detection result to the controller 12. The load detector 16 detects and outputs the load value of the load 20 to the controller 12.

The controller 12 switches, on and off, the switch unit 103 according to the load value of the load 20 and the condition of the apparatus, selects an arbitrary fuel cell stack of either the first fuel cell stack 101 and the second fuel cell stack 102, and connects the arbitrary fuel cell stack to the load 20. Here, described is an example in which only the first fuel cell 101 is connected to the load 20.

The power generation part is selected according to the total power generation time between the load 20 connected to the first fuel cell stack 101 and the second fuel cell stack 102, which is output from the management unit 13 of FIG. 1. The selection of the fuel cell stacks is determined according to the on and off time of the load 20 connected to the first fuel cell stack 101 and the second fuel cell stack 102 or the total power generation time. The life time of the first fuel cell stack 101 and the second fuel cell stack 102 can be adjusted by this selection.

Then, the controller 12 controls the fuel feed pump 6a and the liquid feed pump 6b to feed the liquid fuel mixture in the mixing tank 5 so that the fuel cell stack 101 generate electric power. A part of the liquid fuel mixture that is not used for the power generation and exhaust fluids generated by the power generation is discharged to mixing tank 5 through the line L5.

While the first fuel cell stack 101 is generating electricity, the ambient temperature thermometer 8 measures the ambient temperature of the first fuel cell stack 101 and outputs the measurement results to the controller 12. In addition, the liquid temperature thermometer 9 measures the temperature of the liquid fuel mixture and outputs the measurement results to the controller 12.

The controller 12 reads out a set temperature value and compares the ambient temperature with the set temperature value. The controller 12 calculates a temperature difference between the ambient temperature and measured temperature of the liquid fuel mixture and compares the temperature difference with an allowable temperature range, stored in the memory 18. The controller 12 controls the coolers 7a and 7b and feed of the liquid fuel mixture to the first fuel cell stack 101 and the second fuel cell stack 102.

In the method of controlling the fuel cell system 1 according to the embodiment, the amount of water collected from the anode electrodes of the first fuel cell stack 101 and the second fuel cell stack 102 is stably controlled, the power generation efficiencies are set within the optimized range, the load can be widely varied, and miniaturization can be achieved.

Various modifications will become possible for those skilled in the art after receiving the teachings of the present disclosure without departing from the scope thereof.

What is claimed is:

1. A fuel cell system comprising:
a plurality of fuel cell stacks;
a mixing tank in which a liquid fuel mixture is stored, the liquid fuel mixture containing mixing a fuel and an exhaust fluid from the fuel cell stacks;
a liquid feed pump configured to feed the liquid fuel mixture to the fuel cell stacks;
a switch unit configured to switch on and off a load connected with the fuel cell stacks:
an ambient thermometer provided adjacent to the fuel cell stacks, measuring an ambient temperature of the fuel cell stacks: and
a controller configured to control the feed of the fuel mixture to the fuel cell stacks, according to the ambient temperature.

2. The system of claim 1, further comprising a liquid thermometer measuring a temperature of the liquid fuel mixture, wherein the controller controls the feed of the liquid fuel mixture for each of the fuel cell stacks, according to a temperature difference between the ambient temperature and the temperature of the liquid fuel mixture.

3. The system of claim 1, further comprising a plurality of coolers each provided adjacent to the fuel cell stacks, respectively, wherein the controller controls the coolers according to the ambient temperature.

4. The system of claim 1, wherein the controller controls the switch unit so that the liquid fuel mixture is fed to an arbitrary fuel cell stack when the load connected to the arbitrary fuel cell stack is switched off.

5. The system of claim 1, further comprising:
a management unit configured to manage power generation time of each of the fuel cell stacks by counting on and off time of the load applied to each fuel cell stacks, wherein the controller controls the switching unit according to the power generation time.

6. The system of claim 1, further comprising:
a valve configured to control a flow of the liquid fuel mixture to the fuel cell stacks, wherein the controller controls the feed of the fuel mixture by controlling the valve.

7. The system of claim 1, wherein the controller controls the switch unit according to a charge level in a secondary battery connected to the fuel cell stacks.

8. The system of claim 1, further comprising a load detector configured to detect a condition of the load, wherein the controller controls the switch unit according to a detection result of the load detector.

9. The system of claim 1, wherein the fuel cell stacks are electrically connected in series.

10. The system of claim 1, wherein the fuel includes methanol and the exhaust fluid includes water.

11. A fuel cell system comprising:
a plurality of fuel cell stacks;
a mixing tank in which a liquid fuel mixture is stored, the liquid fuel mixture containing a fuel and an exhaust fluid from the fuel cell stacks;
a plurality of liquid feed pumps configured to feed the liquid fuel mixture to the fuel cell stacks, respectively;
a switch unit configured to switch on and off a load connected with the fuel cell stacks:
an ambient thermometer provided adjacent to the fuel cell stacks, measuring an ambient temperature of the fuel cell stacks: and
a controller configured to control the feed of the fuel mixture to the fuel cell stacks by controlling the liquid feed pumps, according to the ambient temperature.

12. The system of claim 11, further comprising a liquid thermometer measuring a temperature of the liquid fuel mixture, wherein the controller controls the feed of the liquid fuel mixture for each of the fuel cell stacks, according to a temperature difference between the ambient temperature and the temperature of the liquid fuel mixture.

13. The system of claim 11, further comprising a plurality of coolers each provided adjacent to the fuel cell stacks, respectively, wherein the controller controls the coolers according to the ambient temperature.

14. The system of claim 11, wherein the controller controls the switch unit so that the liquid fuel mixture is fed to an arbitrary fuel cell stack when the load connected to the arbitrary fuel cell stack is switched off.

15. The system of claim 11, further comprising:
a management unit configured to manage power generation time of each of the fuel cell stacks by counting on and off time of the load applied to each fuel cell stacks, wherein the controller controls the switching unit according to the power generation time.

16. A method of controlling a fuel cell system, comprising:
connecting an arbitrary fuel cell stack with a load, the arbitrary fuel cell selected from a plurality of fuel cell stacks electrically connected in series;
generating electricity by feeding a liquid fuel mixture to the arbitrary fuel cell, the liquid fuel mixture containing a fuel and an exhaust fluid from the fuel cell stacks;
measuring an ambient temperature of the arbitrary fuel cell stack;
controlling a cooler provided adjacent to the arbitrary fuel cell stack and an amount of the liquid fuel mixture fed to the fuel cell stacks, according to a measurement result of the ambient temperature.

17. The method of claim 16, further comprising measuring a temperature of the liquid fuel mixture, wherein the cooler and the amount of the liquid fuel mixture are controlled by a temperature difference between the ambient temperature and the temperature of the liquid fuel mixture.

18. The method of claim 16, further comprising feeding the liquid fuel mixture to at least one of the fuel cell stacks other than the arbitrary fuel cell stack while the arbitrary fuel cell stack generates electricity.

19. The method of claim 18, further comprising managing power generation time of each of the fuel cell stacks by counting on and off time of the load applied to each fuel cell stacks.

20. The method of claim 18, further comprising:
detecting a charge level in a second battery connected to the fuel cell stack; and
controlling generation of the electricity, according to a detection result of the charge level.
